(19) United States
(12) Patent Application Publication
(10) Pub. No.: US 2025/0129233 A1
(43) Pub. Date: Apr. 24, 2025

(54) HEAT STABILIZER FOR CHLORINE-CONTAINING POLYMERS

(71) Applicants: Galata Chemicals GmbH, Lampertheim (DE); GALATA CHEMICALS LLC, Jersey City, NJ (US)

(72) Inventors: Frank ABRAHAM, Worms (DE); Peter FRENKEL, Danbury, CT (US)

(21) Appl. No.: 18/730,018

(22) PCT Filed: Jan. 16, 2023
(86) PCT No.: PCT/US2023/010860

§ 371 Date: Jul. 18, 2024

Related U.S. Application Data
(60) Provisional application No. 63/300,705, filed on Jan. 19, 2022.

(51) Int. Cl. C08K 3/32; C08K 3/30; C08K 3/34; C08K 5/00; C08K 5/3462

(52) U.S. Cl. CPC C08K 3/32; C08K 3/34; C08K 5/0091; C08K 5/3462; C08K 2003/309

(57) ABSTRACT

A heat stabilizing composition for chlorine-containing polymers, such as PVC and CPVC, comprising alkali metal hydrogen phosphites that can also be used as sole stabilizers.

### FIELD OF THE INVENTION

The present invention relates to heat stabilizer compositions. More particularly, the present invention relates to heat stabilizer compositions comprising phosphorous-containing components for protecting chlorine-containing polymers against thermal degradation.

### BACKGROUND OF THE INVENTION

Due to their superior performance characteristics, chlorine-containing polymers, such as polyvinyl chloride (PVC) and chlorinated polyvinyl chloride (CPVC), for example, are a primary material in construction profiles, sidings, roofings, films/sheets, fabrics, pipes, fittings, flooring and cables. Various additives, such as heat stabilizers are commonly included when formulating compositions containing chlorine-containing polymers. Heat stabilizers are required because as PVC and/or CPVC is heated to temperatures of 160° C. and above, decomposition reactions begin, and the polymer releases HCl. As such decomposition continues, it further accelerates HCl elimination and decomposition. A variety of liquid and solid stabilizers are known to be effective in reducing and/or preventing the decomposition and discoloration of halogen-containing polymers at elevated temperatures, for example, “PVC Degradation and Stabilization,” Wypich, George, ChemTec, Toronto 2008; “Handbook of Vinyl Formulating”, 2nd edition, Grossman, Richard F., Wiley & Sons, 2008; and “PVC Handbook”, Wilkes, Charles E., et al, Hanser, Cincinnati 2005. Efforts have been ongoing to develop improved heat stabilizers.

Tri-alkyl, tri-aryl and aryl-alkyl phosphite esters have been used as co-stabilizers or components of heat stabilizers for both non-plasticized (rigid) and plasticized PVC compounds. These phosphites are commonly liquid substances and are selected from triaryl phosphites such as triphenyl phosphite, tris(amylphenyl) phosphite and tris(nonylphenyl) phosphite; diphenyl alkyl phosphites, such as diphenyl isodecyl phosphite, diphenyl tridecyl phosphite and 2-ethylhexyl diphenyl phosphite, diphenyl phosphite; phenyl dialkyl phosphites, such as phenyl diisodecyl phosphite, and tris(alkyl) phosphites, such as trilauryl phosphite, tri-isodecyl phosphite, tri-isotridecyl phosphite, tri-lauryl phosphite and tris(2-ethylhexyl) phosphite, poly (dipropylene glycol) phenyl phosphite, tetraphenyl dipropyleneglycol diphosphite, phenyl neopentylene glycol phosphite, tris(dipropyleneglycol) phosphite, poly 4,4′ isopropylidenediphenol-C₁₀ alcohol phosphite and poly 4,4′ isopropylidenediphenol-C₁₂₋₁₅ alcohol phosphite.

Organic phosphite esters have been used in PVC formulations, e.g., U.S. Pat. No. 2,834,798 describes the preparation of cyclic phosphite esters. U.S. Pat. Nos. 3,205,250, 3,281,381, 4,206,103, 4,290,976 and 6,362,260 cover synthesis and use of penthaerythritol-based phosphites as stabilizing components for PVC. U.S. Pat. No. 7,468,410 details the preparation of tris(monoalkyl)phenyl phosphite esters and their use for stabilizing polyolefins. U.S. Pat. No. 7,470,735 covers the synthesis of phenol-free aryl-alkylphosphites for use in halogenated resins, where the aryl groups were nonylphenyl, bis(nonylphenyl) and para-cumylphenyl. U.S. Pat. No. 8,258,215 discloses synthesis of aryl-alkyl phosphites, where the aryl groups were para-cumylphenyl and bis(para-cumyl)phenyl, and their use in stabilizing PVC, polyethylene, polypropylene and SBR rubber. GB 2,489,896 describes the preparation of phenol-free tri-alkylphosphite esters. CA 2,789,387 details the preparation of alkylphenol-free polymeric polyalkyl phosphites, where the alkyl groups include cycloalkyl, alkenyl, cycloalkenyl, and methoxyl alkyl glycol ethers; for example, polyethylene glycols and polypropylene glycols (hydroxy polyethers).

Phosphite esters have been used in combination with other stabilizing components, e.g., U.S. Pat. No. 8,575,247 is a specific example of using phosphite esters in combination with organotin co-stabilizers in rigid PVC compounds.

U.S. Pat. No. 4,797,426 covers the use of dibasic lead phosphites of 2PbO·PbHPO₃·H₂O that have shown high efficiency for thermal and UV-light stability and weathering performance. U.S. Pat. No. 4,221,687 lists CaHPO₃·5Ca (OH) 2 and CaO·CaHPO₃ as co-stabilizers for PVC.

U.S. Pat. Nos. 5,298,545, 5,356,982 and 6,084,013 disclose the use of inorganic basic calcium aluminum hydrogen phosphites of general formula I and II as stabilizing components for halogen-containing polymers, especially PVC.
CaₓAl₂ (OH)₂₍ₓ₊₂₎ HPO₃·mH₂O (I), wherein x=3-8 and m=0-12.
CaₓAl₂ (OH)_{2(x+3-y)} (HPO₃)_{y}·mH₂O (II), wherein x=2-12 and m=0-12.

U.S. Pat. No. 5,938,977 describes the use of the hydrogen phosphite of formula II in combination with various co-stabilizers. U.S. Pat. Nos. 9,481,831, 9,505,904 and 10,421,909 disclose the use of basic aluminum-alkali metal hydrogen phosphites with and without aluminum hydrogen phosphite/aluminum dihydrogen phosphites as flame retardant agents for thermoplastics or thermosets or mixtures thereof. U.S. Pat. No. 10,202,549 covers the use of aluminum hydrogen phosphite as a component of flame retardants, while US20150299419 discusses the use of aluminum hydrogen phosphite/aluminum dihydrogen phosphites as flame retardants.

While lead-based stabilizers are toxic, basic calcium aluminum hydrogen phosphites have been found to have limited dispersability in chlorine-containing polymers.

U.S. Pat. No. 2,604,459 describes a method that comprises wetting chlorine-containing polymers with an acidic aqueous solution of a stabilizer selected from the group consisting of alkali metal pyrophosphates, orthophosphates and phosphites, and the applicable acidified solution is of pH 3.5-5.0, while the preferred stabilizer is tetra-sodium pyrophosphate.

Therefore, use of alkali metal hydrogen phosphites (either solid or in solution) as heat stabilizers has not been mentioned.

### SUMMARY OF THE INVENTION

The subject matter of the present disclosure relates to heat stabilizer compositions containing phosphorous-containing components for protecting chlorine-containing polymers against thermal degradation.

In one embodiment, the present disclosure provides a heat stabilizer composition comprising an alkali metal hydrogen phosphite.

In another embodiment, the present disclosure provides a composition comprising a chlorine-containing polymer and a stabilizer composition comprising an alkali metal hydrogen phosphite.

In still another embodiment, the present disclosure provides a method of stabilizing chlorine-containing polymers, comprising incorporating into the chlorine-containing polymers a stabilizer composition comprising phosphorous-containing components for protecting chlorine-containing polymers against thermal degradation.

### DETAILED DESCRIPTION OF THE INVENTION

The subject matter of the present disclosure provides an inorganic phosphorous-containing heat stabilizer component for chlorine-containing polymers. It has surprisingly been found that contrary to information in U.S. Pat. No. 2,604,459, both solid dialkali metal hydrogen phosphites and their non-acidified solutions function as stabilizers for chlorine-containing polymers, reducing their thermal degradation when used by themselves or in combination with other co-stabilizers that synergistically enhance heat stability of the chlorine-containing polymers.

### Chlorine-Containing Polymers

For the purpose of this specification, the term chlorine-containing polymers is intended to include homopolymers and copolymers of vinyl chloride, i.e., vinyl resins containing vinyl chloride units in their structure, e.g., copolymers of vinyl chloride and vinyl esters of aliphatic acids, in particular vinyl acetate; copolymers of vinyl chloride with esters of acrylic and methacrylic acid and with acrylonitrile; copolymers of vinyl chloride with diene compounds and unsaturated dicarboxylic acids or anhydrides thereof, such as copolymers of vinyl chloride with diethyl maleate, diethyl fumarate or maleic anhydride; post-chlorinated polymers and copolymers of vinyl chloride; copolymers of vinyl chloride and vinylidene chloride with unsaturated aldehydes, ketones and others, such as acrolein, crotonaldehyde, vinyl methyl ketone, vinyl methyl ether, vinyl isobutyl ether, and the like. Preferably, the chlorine-containing polymer is PVC.

The term PVC as employed herein is also intended to include graft polymers of PVC with ethyl-vinyl acetate (“EVA”), acrylonitrile/butadiene-styrene (“ABS”), and meth-acrylate-butadiene-styrene (“MBS”). Preferred substrates are also mixtures of the above-mentioned homopolymers and copolymers, preferably vinyl chloride homopolymers, with other thermoplastic and/or elastomeric polymers, more preferably blends with ABS, MBS, acrylonitrile butadiene (“NBR”), styrene-acrylonitrile (“SAN”), EVA, chlorinated polyethylene (“CPE”), poly(methyl methylacrylate), ethylene propylene diene monomer (“EPDM”), and polylactones. Preferably, vinyl acetate, vinylidene dichloride, acrylonitrile, chlorofluoroethylene and/or the esters of acrylic, fumaric, maleic and/or itaconic acids are monomers that are copolymerizable with vinyl chloride. Polymeric materials stabilized with the stabilizers of this invention also include post-chlorinated polyvinyl chloride (CPVC). The most preferred chlorine-containing polymers are PVC, CPVC and their mixtures.

### Alkali Metal Hydrogen Phosphites

Inorganic phosphorous-containing components of this invention for stabilizing chlorine-containing polymers comprise alkali metal salts of phosphorous acid (also known as inorganic hydrogen phosphites or hydrogen phosphonates) described by formula III:
M₂HPO₃·mH₂O (III), where M=Li, Na, K, Rb, Cs and their mixtures; m=0-10.

These dialkali metal hydrogen phosphites (AMHP) are typically used in combination with other co-stabilizers. AMHP are added to chlorine-containing polymers at 0.1-5.0 parts per hundred (“phr”), preferably at 0.1-1.0 phr. The most preferred AMHP of the current subject matter is disodium hydrogen phosphite (DSP). It contains 5 molecules of crystalline water, so that in formula III m=5. Preferably, aqueous solutions of the claimed AMHP-containing compositions are of pH greater than 5.0, preferably greater than 8 and up to 10. For example, a 10% aqueous solution of DSP exhibits a pH of about 9. DSP is introduced in the chlorine-containing polymer compounds either as a solid at 0.1-5.0 phr, preferably at 0.1-1.0 phr, or as 1-50% aqueous solutions, preferably 20-40% aqueous solutions at 0.1-5.0 phr solid DSP, preferably at 0.1-1.0 phr. The solutions are prepared either by reacting alkali metal hydroxides with phosphorous acid or by dissolving solid DSP in water at ambient or elevated temperatures. The solutions can either be sprayed on solid components or introduced into the dry blend as is.

The most preferred co-stabilizers that can be used in combination with AMHP are alkyltin compounds, hydrotalcites, zeolites, certain nitrogen-containing compounds, organic phosphite esters, certain mixed metal compounds, alkali metal salts of perchloric acid, alkali and earth alkali salts of mono- and dicarboxylic acids and mixtures thereof.

### Co-Stabilizers

In addition to AMHP, the stabilizer compositions may contain co-stabilizers. Co-stabilizers which can be present in the stabilizer compositions comprising AMHP include alkyltin compounds, layered lattice compounds (calcium-aluminum hydroxycarbonates known also as hydrotalcites), zeolites, nitrogen-containing compounds, organic phosphite esters, mixed metal compounds, alkali metal salts of perchloric acid, alkali metal salts of dicarboxylic acids and mixtures thereof.

### Alkyltin Compounds

When the heat stabilizer composition of the current subject matter contains an alkyltin compounds, the alkyltin compound is preferably selected from alkyltin mercaptides, alkyltin carboxylates, alkyltin sulfides or mixtures thereof.

Alkyltin mercaptides may preferably include alkyltin mercaptocarboxylic acid esters and alkyltin 2-mercaptoethylcarboxylates. Preferred examples of liquid alkyltin mercaptocarboxylic acid ester components include: mono-alkyltin tris(2-ethylhexyl mercaptoacetate), di-alkyltin bis(2-ethylhexyl mercaptoacetate), dialkyltin bis(ethylene glycol di-mercaptoacetate) and mixtures thereof, where the alkyl group is selected from C₁-C₁₂ linear, branched or cyclic hydrocarbons. Preferably, the alkyl groups are selected from methyl, n-butyl or n-octyl. The weight ratio of the mono- to dialkyltin mercaptides ranges from 1/99 to 99/1, preferably from 5/95 to 95/5 and more preferably from 95/5 to 50/50.

The alkyl groups in the alkyltin 2-mercaptoethylcarboxylates are preferably selected from C₁-C₁₂ linear, branched or cyclic hydrocarbons. Preferably, the alkyl groups are methyl or n-butyl. Preferred examples of liquid alkyltin 2-mercaptoethylcarboxylates include dimethyltin bis(2-mercaptoethyltallate), mono-methyltin tris(2-mercaptoethyltallate), dibutyltin bis(2-mercaptoethyltallate), mono-butyltin tris(2-mercaptoethyltallate) and their mixtures.

Preferably, the alkyltin carboxylates are dialkyltin bis(carboxylate) components that are selected from dialkyltin bis (ethylmaleate), dialkyltin bis(2-ethylhexyl maleate), dialkyltin bis (laurate), dialkyltin bis (neodecanoate), dialkyltin bis(2-ethylhexanoate), dialkyltin bis (oleate), dialkyltin bis(2-ethylhexanoate) or mixtures thereof, where the alkyl group is selected from C₁-C₁₂ linear, branched or cyclic hydrocarbons. Preferably, the alkyl groups are methyl, n-butyl or n-octyl. The dialkyltin bis(carboxylates) may contain mono-alkyltin tris(carboxylates).

When alkyltin sulfides are the alkyltin stabilizers, the alkyl groups are selected from C₁-C₁₂ linear, branched or cyclic hydrocarbons. Preferably, the alkyl groups are methyl, n-butyl or n-octyl. Preferably, the alkyltin sulfide is a dibutyltin sulfide. Suitable alkyltin mercaptides and alkyltin sulfides are also disclosed in U.S. Pat. No. 4,255,320.

The alkyltin compounds can be present in heat stabilizing compositions comprising the AMHP of this invention and chlorine-containing polymers in an amount of from 0.01 to 10, preferably from 0.05 to 5, and more preferably from 0.1 to 3 parts by weight per 100 parts by weight of chlorine-containing polymers.

### Hydrotalcites

Examples of hydrotalcites that may be used as co-stabilizers are compounds known to those skilled in the art as shown, for example, in DE 384 35 81, EP 0 062 813 and WO 1993/20135.

Hydrotalcites that can be present in the compositions preferably include those of the general formula: M²⁺₁₋ₓM³⁺ₓ (OH)₂ (An^{b-})_{x/b}dH₂O, wherein M²⁺ represents one or more metals from the group Mg, Ca, Sr, Zn and Sn, M³⁺ represents Al or B, An is an anion having the valency n, b is a number from 1 to 2, 0<x<0.5, and d is a number in the range from 0 to 300, preferably in the range from 0.5 to 30. Preferably, An is OH⁻, HCO₃⁻, or CO₃²⁻.

Examples of hydrotalcites include Al₂O₃6MgO CO₂12H₂O (i), Mg_{4,5} Al₂ (OH)_{1.3}CO₂ 3.5H₂O (ii), 4MgOAl₂O₃CO₂9H₂O (iii), 4MgOAl₂O₃CO₂6H₂O (iv), ZnO 3MgOAl₂O₃CO₂8-9H₂O (v), and ZnO 3MgOAl₂O₃CO₂5-6H₂O (vi). Preferred are types i, ii and iii.

The hydrotalcites preferably can be present in the chlorine-containing polymer in an amount of from 0.1 to 20 parts by weight, preferably from 0.1 to 10 parts by weight and more preferably from 0.1 to 5 parts by weight per 100 parts by weight of chlorine-containing polymer.

### Zeolites

Zeolite co-stabilizers are preferably described by the general formula: M_{x/n} [(AlO₂)×(SiO₂)_{y}]wH₂O, wherein n is the charge of the cation M, M is an element from the first or second main groups of the Periodic Table, such as Li, Na, K, Mg, Ca, Sr or Ba; y and x are numbers that range from 0.8 to 15, preferably from 0.8 to 1.2; and w is a number from 0 to 300, preferably from 0.5 to 30. Examples of zeolites include sodium aluminosilicates of the following types: zeolite A, zeolite Y, zeolite X, zeolite LSX; or the zeolites prepared by complete or partial replacement of the Na atoms by Li, K, Mg, Ca, Sr or Zn atoms. The preferred Si/Al ratio is about 1:1. Preferred zeolites are Na zeolite A and Na zeolite P. The zeolites are used in an amount from 0.1 to 10.0 parts by weight based on 100 parts of chlorine-containing polymers.

### Nitrogen-Containing Compounds

Nitrogen-containing compounds that can be used in heat stabilizers comprising AMHP of this invention are preferably selected from thiourea as well as uracil-based heavy metal-free components described in U.S. Pat. No. 5,925,696, the disclosure of which is hereby incorporated by reference. They can be present in the chlorine-containing polymers in the amount of from 0.1 to 10 parts by weight, preferably from 0.1 to 5 parts by weight and more preferably from 0.1 to 1.0 parts by weight per 100 parts by weight of chlorine-containing polymers. The preferred example of the nitrogen-containing compounds is 6-amino-1,3-dimethyluracil.

### Organic Phosphite Esters

Suitable phosphites are preferably selected from triphenyl phosphite, diphenyl isodecyl phosphite, ethylhexyl diphenyl phosphite, phenyl diisodecyl phosphite, trilauryl phosphite, triisononyl phosphite, triisodecyl phosphite, epoxy grade triphenyl phosphite, diphenyl phoshite, tris(nonylphenyl) phosphite, phosphites of polyols or mixtures thereof. The phosphites can be present in the compound in an amount of from 0.01 to 10 parts by weight, preferably from 0.05 to 5 parts by weight, and more preferably from 0.1 to 3 parts by weight per 100 parts by weight of chlorine-containing polymers.

### Mixed Metal Compounds

The mixed metal compounds preferably comprise a zinc salt and at least one metal salt, where the metal is selected from Li, Na, K, Mg, Ca, Sr, Ba, Cd, Pb, Al, La, Ce or rare earth metals. Preferably, the mixed metal compounds comprise barium and zinc, magnesium and zinc, calcium and zinc, or calcium, magnesium and zinc.

Preferably, the zinc and metal compounds are independently selected from carboxylates, overbased carboxylates, glycerolates, oxides, hydroxides, phosphites, perchlorates, carbonates, basic carbonates or benzoates; where the carboxylates are independently selected from benzoates, oleates, stearates, neodecanoates, palmitates, soyates, tallates, myristylates, hydroxystearates, dihydroxy-stearates, laurates, 2-ethylhexanoates and salts of shorter-chain alkanecarboxylic acids.

Preferably, the zinc and metal carboxylates are independently selected from the zinc, calcium, magnesium, or barium carboxylates of carboxylic acids having 7 to 18 carbon atoms. More preferably, the zinc and metal carboxylates are independently selected from the zinc, calcium, magnesium or barium salts of monovalent carboxylic acids such as octanoic, neodecanoic, 2-ethylhexanoic, decanoic, undecanoic, dodecanoic, tridecanoic, myristic, palmitic, isostearic, stearic, 12-hydroxystearic, lauric, behenic, and sorbic acid; and the calcium, magnesium and zinc salts of divalent carboxylic acids, such as oxalic, malonic, succinic, glutaric, adipic, fumaric, phthalic, isophthalic, terephthalic, hydroxyphthalic acid and citric acid. Overbased carboxylates, such as overbased zinc octoate and overbased calcium or barium soaps, are also preferred. The zinc compound is typically present in the mixed metal stabilizer in an amount up to 25% based on the weight of the mixed metal stabilizer. Preferably, the zinc compound is present in an amount from 0.005% to 10%, based on the weight of the mixed metal stabilizer. The metal compound is present in the mixed metal stabilizer in an amount up to 35% based on the weight of the mixed metal stabilizer. Preferably, the metal compound is present in an amount from 0.001% to 15% based on the weight of the mixed metal stabilizer.

The mixed metal stabilizer is preferably present in the compound in an amount of from 0.001 to 10 parts by weight, preferably from 0.01 to 8 parts by weight, and more preferably from 0.05 to 5 parts by weight per 100 parts by weight of chlorine-containing polymers. Preferably, the metal/zinc compounds are selected from the groups of calcium/zinc or barium/zinc compounds.

### Alkali Metal Salts of Perchloric Acid

For the purposes of the present invention, examples of these materials include Li, Na, K, Rb and Cs salts of perchloric acid. The preferred alkali metal salt of perchloric acid is sodium perchlorate. The preferred loadings are 0.1-5.0 phr, more preferred loading is 0.1-1.0 phr.

### Alkali Metal Salts of Dicarboxylic Acids

For the purposes of the present invention, examples of these materials preferably include salts of Li, Na, K, Rb and Cs and dicarboxylic acids selected from the group consisting of saturated and unsaturated dicarboxylic acids containing a total of C₂-C₁₀ carbon atoms, including succinic acid, glutaric acid, adipic acid, fumaric acid, azelaic acid, sebacic acid, itaconic acid, phthalic acid, iso-phthalic acid, tere-phthalic acid and mixtures thereof. Examples of preferred alkali metal salts of dicarboxylic acids are sodium adipate and sodium sebacate.

The preferred loadings are 0.1-5.0 phr, more preferred loading is 0.1-2.0 phr.

### Additives

Optionally, the PVC compounds may also include one or more additives to enhance or modify chemical or physical properties, such as heat stability, lubricity, color, and viscosity. Exemplary additives include, but are not limited to, plasticizers, lubricants, viscosity control agents, UV absorbers, antioxidants, process aids, impact modifiers, antistatic agents, antimicrobials and antifungal compounds, fillers, fusion promoters, pigments, flame retardants, smoke suppressants, chemical foaming agents, reinforcing agents, metal release agents, dispersants among other compounds conventionally used in rigid and flexible PVC formulations. These additives may be added to the chlorine-containing resins using techniques and equipment well known to those of ordinary skill in the art. An overview of these can be found in Plastics Additives Handbook, 4th edition, editors: R. Gächter and H. Müller, associate editor: P. P. Klemchuk; Hanser Publishers, Munich, (1993) and Plastics Additives and Modifiers Handbook, ed. J. Edenbaum; Van Nostrand Reinhold, (1992), which are incorporated by reference herein in their entirety.

### Plasticizers

Chlorine-containing polymers may contain one or more plasticizers and their blends. Exemplary plasticizers are branched and linear ortho- and tere-phthalates, hydrogenated phthalates, aliphatic esters of dicarboxylic acids, polymeric esters of dicarboxylic acids, citrates, sucrose esters, levulinic ketal esters, phosphates, alkyl phenol sulfonates, pyrrolidones, trimellitates, esters of benzoic acid, epoxidized oils, epoxidized mono-esters of fatty acids, dialkylthiodiesters and the like. An overview of conventional plasticizers is found at PLASTICS ADDITIVES HANDBOOK, 4th edition, ed. Gächter/Müller, Hansa Gardner Publishers, Munich, 1993, pg. 327-422, which is incorporated by reference herein in its entirety. Preferably, the plasticizers are selected from the group consisting of phthalates, substantially fully esterified mono-, di- and tribasic acids, adipates, azelates, succinates, glutarates, glycol esters, sucrose esters, levulinic ketal esters, citrates, phosphates, alkyl phenol sulfonates, pyrrolidones, epoxidized esters and mixtures thereof. The plasticizers are added at 1.0-70.0 phr, preferably at 10.0 to 40.0 phr to the chlorine-containing polymers, reducing their hardness.

### Lubricants

Suitable lubricants are selected from fatty acids, fatty alcohols, montan wax, fatty acid esters, polyethylene waxes, amide waxes, chloroparaffins, glycerol esters, alkaline earth metal soaps, fatty ketones, or mixtures thereof. Preferably, the lubricant is stearic acid. The lubricants can be present in amounts from 0.1 to 0.5 parts by weight, based on 100 parts by weight of chlorine-containing polymer.

### Fillers

Suitable fillers are preferably selected from calcium carbonate, dolomite, wollastonite, magnesium oxide, magnesium hydroxide, silicates, china clay, talc, glass fibers, glass beads, wood flour, mica, metal oxides or metal hydroxides, carbon black, graphite, rock flour, heavy spar, glass fibers, talc, kaolin, chalk or mixtures thereof. The fillers can be present in amounts of 1 to 100 parts by weight, more preferably in amounts of 1 to 40 parts by weight and most preferably in amounts of 10 to 30 parts by weight, based on 100 parts by weight of chlorine-containing polymers.

### Pigments

Suitable pigments are preferably selected from TiO₂, calcium silicate, pigments based on zirconium oxide, BaSO₄, and zinc oxide (zinc white) or mixtures thereof. The pigments can be present in amounts of 1 to 20 parts by weight, based on 100 parts by weight of chlorine-containing polymers.

### Antioxidants

Suitable antioxidants are preferably selected from alkylated monophenols such as 2,6-di-tert-butyl-4-methylphenol, alkylthiomethylphenols, 2,4-dioctylthiomethyl-6-tert-butylphenol; alkylated hydroquinones such as 2,6-di-tert-butyl-4-methoxyphenol; hydroxylated thiodiphenyl ethers such as 2,2′-thiobis(6-tert-butyl-4-methylphenol); alkylidenebisphenols such as 2,2′-methylene-bis(6-tert-butyl-4-methylphenol); benzyl compounds such as 3,5,3′,5′-tetratert-butyl-4,4′-dihydroxydibenzyl ether; hydroxybenzylated malonates, such as dioctadecyl 2,2-bis(3,5-di-tert-butyl-2-hydroxybenzyl) malonate; hydroxybenzyl aromatics such as 1,3,5-tris(3,5-di-tert-butyl-4-hydroxybenzyl)-2,4,6-trimethylbenzene; triazine compounds such as 2,4-bisoctylmercapto-6-(3,5-di-tert-butyl-4-hydroxyanilino)-1,3,5-triazine; phosphonates and phosphonites such as dimethyl 2,5-di-tert-butyl-4-hydroxybenzylphosphonate; acylaminophenols such as 4-hydroxylauranilide; esters of β-(3,5-ditert-butyl-4-hydroxyphenyl) propionic acid such as pentaerythritol tetrakis(3-(3,5-di-tert-butyl-4-hydroxyphenyl) propionate), octadecyl-3-(3,5-di-tert-butyl-4-hydroxyphenyl) propionate, β-(5-tert-butyl-4-hydroxy-3-methylphenyl) propionic acid, and β-(3,5-dicyclohexyl-4-hydroxyphenyl) propionic acid; esters of 3,5-ditert-butyl-4-hydroxyphenylacetic acid with mono- or polyhydric alcohols; amides of β-(3,5-ditert-butyl-4-hydroxyphenyl) propionic acid such as N,N′-bis(3,5-ditert-butyl-4-hydroxyphenyl-propionyl) hexamethylenediamine; vitamin E (tocopherol) and derivatives or mixtures thereof. The antioxidants can be present in amounts of 0.01 to 10 parts by weight, preferably, 0.1 to 5 parts by weight and more preferably from 0.1 to 3 parts by weight, based on 100 parts by weight of chlorine-containing polymers.

### UV Absorbers and Light Stabilizers

The UV absorbers and light stabilizers are preferably selected from 2-(2′-hydroxyphenyl)benzotriazoles such as 2-(2′-hydroxy-5′-methylphenyl)-benzotriazole, 2-hydroxybenzophenones; esters of unsubstituted or substituted benzoic acids such as 4-tert-butylphenyl salicylate and phenyl salicylate; acrylates; nickel compounds; oxalamides such as 4,4′-dioctyloxyoxanilide, and 2,2′-dioctyloxy-5,5′-ditert-butyloxanilide; 2-(2-hydroxyphenyl)-1,3,5-triazines such as 2,4,6-tris(2-hydroxy-4-octyloxyphenyl)-1,3,5-triazine, 2-(2-hydroxy-4-octyloxyphenyl)-4,6-bis(2,4-dimethylphenyl)-1,3,5-triazine; sterically hindered amines such as bis(2,2,6,6-tetramethylpiperidin-4-yl) sebacate, bis(2,2,6,6-tetramethylpiperidin-4-yl) succinate or mixtures thereof.

### Blending

The chlorine-containing polymers and the stabilizers may preferably be combined via dry blending followed by compounding steps, such as molding (injection molding, compression molding, blow molding, slush molding, rotational molding), calendaring, extrusion, paste forming or directly by compounding steps, such as molding (injection molding, compression molding, blow molding, slush molding, rotational molding), calendaring, extrusion, and paste forming.

The chlorine-containing polymers with heat stabilizers and optional additives can preferably be fabricated into semi-finished goods and articles, including film, sheet, foamed sheet, flooring, weatherable exterior, siding capstock and substrate, doors, decking, profiles, pipes, roofing, automotive, packaging, medical devices, toys or waterproofed articles. Such articles can be produced via molding, calendaring or extrusion as discussed above.

### EXAMPLES

The following Examples further detail and explain preparation of DSP-containing PVC and CPVC compounds, and demonstrate their efficacy for preventing/reducing discoloration (caused by high in-process shear and exposure to heat) and enhance their thermal stability in the presence of DSP. These examples merely illustrate the invention. Those skilled in the art will recognize many variations that are within the spirit of the invention and scope of the claims.

### Raw Materials, Test Methods and Sample Preparation

Disodium hydrogen phosphonate pentahydrate (DSP) was received from Sigma-Aldrich, and it was used as received.

### Co-Stabilizers:

Mono-octyltin tris(2-ethylhexyl mercaptoacetate) (“MOTE”), a liquid of high purity manufactured by Galata Chemicals, GmbH as Mark 21 MOK-A.

Mono-methyltin tris(2-ethylhexyl mercaptoacetate) (“MMTE”), a liquid of high purity manufactured by Galata Chemicals LLC as Mark 1921E.

Dimethyltin bis(2-ethylhexyl mercaptoacetate) (“DMTE), a liquid reaction mixture manufactured by Galata Chemicals, LLC as Mark 1900.

Dimethyltin bis(2-mercaptoethyl tallate) (“DMTT”), a liquid reaction mixture manufactured by Galata Chemicals, LLC as Mark 1939.

Heavy metal-free stabilizer, containing 1,3-dimethyl-4-aminouracil, sodium perchlorate and Zeolite among other components; it is manufactured by Galata Chemicals, GmbH as Mark OBS 702.

Zeolite, a co-stabilizer, was purchased from PQ Corporation as Advera 401 PS.

### PVC Compounding

The stabilizers of the current subject matter were compounded with other components into rigid PVC or CPVC compounds (using the Brabender torque rheometer, Plastograph type 815605) that were tested for the dynamic heat stability.

### Dynamic Heat Stability Test Method

CPVC dry blend formulations were prepared using the stabilizers of the current subject matter and co-stabilizers described above at the specified amounts expressed in phr of CPVC. Each CPVC compound test sample (prepared according to the formulation described in Table 1) was placed into a Brabender mixer operated at 190° C. and 40 rpm. Sample chips were taken every 3 minutes.

Rigid PVC dry blend formulations were prepared incorporating the stabilizer of this invention and co-stabilizers described above at the specified amounts expressed in phr of PVC. Each PVC compound test sample (prepared according to formulation described in corresponding Tables below) was placed into a Brabender mixer operated at 190° C. and 65 RPM. Sample chips were taken every 3 minutes. Fusion time was approximately the same for each test series.

Heat stability of PVC and CPVC compounds was determined using the microprocessor-controlled Hunterlab Labscan Spectro Colorimeter, Type 5100 measuring Yellowness Index (YI) of the sample chips (in accordance with ASTM D 1925-70 Yellowness Index of plastics). Lower YI signifies lower discoloration as a result of thermal decomposition, and therefore, superior thermal stabilization imparted by a more effective heat stabilizer.

Results of the dynamic heat stability imparted by stabilizers of this invention are shown in Tables 2, 4, 6, 8 10 and 11.

### Example 1. Comparative Testing in CPVC

CPVC compounds were prepared according to the formulation described in Table 1.

TABLE 1
Tested CPVC compounds

| Components | Manufacturer | Loading, phr |
|---|---|---|
| CPVC (Lucalor RB8065) resin | Arkema | 100 |
| Clearstrength C-320 (MBS IM) | Arkema | 7 |
| Kronos 2220 (TiO2) | Kronos | 3.5 |
| Sinoplas FT-108 (FT wax) | Sinoplas | 0.9 |
| AC 629A (oxidized PE wax) | Honeywell | 1 |
| Aklub K-PE 20 (PE wax) | Akdeniz Chemson | 0.25 |
| Irganox 1010 | BASF | 0.25 |
| Stabilizer | Galata Chemicals | See Table 2 |

Brabender Test Conditions: Temperature 190° C., 40 rpm, sample weight 65 g, chips were taken every 3 minutes

TABLE 2
Dynamic Heat Stability of the tested CPVC
compounds (expressed in Yellowness Index)

| | Stabilizers | |
|---|---|---|
| | 1.25 phr Mark OBS 702/0.5 | 1.25 phr Mark OBS 702/0.5 |
| Time, min. | phr Zeolite (control) | phr Zeolite/0.6 phr DSP |
| 3 | 16.67 | 16.99 |
| 6 | 24.52 | 23.80 |
| 9 | 32.38 | 29.64 |
| 12 | 43.54 | 35.31 |
| 15 | 48.43 | 40.74 |
| 18 | 60.79 | 46.17 |
| 21 | 57.17 | 50.66 |
| 24 | Blackened | 59.28 |
| 27 | | 64.94 |
| 30 | | 66.99 |

Results of Table 2 above demonstrate that addition of DSP at 0.6 phr to the Control stabilizer improved heat stability of CPVC in general and specifically extended long-term heat stability imparted by the control stabilizer from 21 to 30 min in the Dynamic Heat Stability test. Additionally, YI values imparted by the stabilizer containing additional 0.6 phr DSP were substantially reduced in the range from 9 to 21 min. The YI reduction ranged from about 2 YI units at 9 min. to about 14 YI units at 18 min., also indicating an improvement in heat stability of the CPVC compound.

### Example 2. Comparative Testing in PVC

PVC compounds were prepared according to the formulation described in Table 3.

TABLE 3
Tested PVC compounds

| Components | Manufacturer | Loadings, phr |
|---|---|---|
| Vynova 6706 (PVC resin) | Vynova | 100.00 |
| Omya 1 TK (filler - CaCO3) | Omya | 5 |
| Kronos 2220 (TiO2) | Kronos | 3 |
| Aklub K-PE 20 (PE wax) | Akdeniz Chemson | 0.8 |
| Aklub K-30 (stearyl stearate) | Akdeniz Chemson | 0.4 |
| AC 629A (oxidized PE wax) | Honeywell | 0.1 |
| Stabilizer | Galata Chemicals | See Table 4 |

Brabender Test Conditions: Temperature 190° C., 65 rpm, sample weight 65 g, chips were taken every 3 minutes

TABLE 4
Dynamic Heat Stability of the tested PVC
compounds (expressed in Yellowness Index)

| | Stabilizers | | |
|---|---|---|---|
| Time, | 2.0 phr Mark OBS | 2.0 phr Mark OBS | 2.0 phr Mark OBS |
| min. | 702 (control) | 702/0.7 phr DSP | 702/3.5 phr DSP-20 |
| 3 | 5.32 | 6.33 | 7.81 |
| 6 | 19.46 | 18.73 | 17.35 |
| 9 | 41.85 | 39.21 | 29.78 |
| 12 | 64.20 | 59.10 | 45.26 |
| 15 | 75.85 | 74.81 | 66.20 |
| 18 | 78.02 | 82.59 | 72.83 |

Results of Table 4 above demonstrate that addition of both pure solid DSP at 0.7 phr and its 20% aqueous solution at 3.5 phr to the Control stabilizer improved the heat stability of PVC, since YI values imparted by the stabilizers containing DSP were reduced in the range from 6 to18 min. It shall be noted that 3.5 phr of DSP-20 (a 20% aq. solution of DSP) contains 0.7 phr of pure solid DSP. This Example 2 shows that while addition of both solid and dissolved DSP reduced the imparted YI, the YI reduction was more pronounced using the aqueous solution of DSP. Specifically, the imparted YI was reduced by 1-5 YI units using pure solid DSP, and it was unexpectedly reduced even more by 2-19 YI units using a 20% aq. solution containing exactly the same amount of pure solid DSP.

### Example 3. Comparative Testing in PVC

PVC film compounds were prepared according to the formulation in Table 5.

TABLE 5
Tested PVC film compounds

| Components | Manufacturer | Loadings, phr |
|---|---|---|
| Vynova S 6030 (PVC resin) | Vynova | 100 |
| Clearstrength C-320 (MBS IM) | Arkema | 6 |
| Loxiol G13 | Emery | 1 |
| Aklub K-PE 20 (PE wax) | Akdeniz Chemson | 0.1 |
| AC 316A (oxidized PE wax) | Honeywell | 0.15 |
| Stabilizer | Galata Chemicals | See Table 6 |

TABLE 6
Dynamic Heat Stability of the tested PVC film
compounds (expressed in Yellowness Index)

| | Stabilizers | | |
|---|---|---|---|
| Time, | 1.2 phr Mark 21 | 1.2 phr Mark 21 | 1.0 phr Mark 21 |
| min. | MOK-A | MOK-A/0.2 phr DSP | MOK-A/0.2 phr DSP |
| 5 | 7.68 | 4.81 | 4.63 |
| 10 | 12.74 | 7.34 | 8.42 |
| 15 | 25.15 | 14.93 | 21.61 |
| 20 | 60.30 | 46.39 | 48.74 |
| 25 | 99.68 | 72.08 | 82.71 |
| 30 | 112.08 | 76.52 | 97.04 |
| 35 | 112.76 | 80.02 | 103.24 |
| 40 | 113.37 | 88.96 | 103.50 |

Results of Table 6 above demonstrate that addition of DSP at 0.2 phr to the Control octyltin stabilizer improved heat stability of PVC, since YI values imparted by the stabilizers containing DSP were reduced. YI values imparted by the stabilizer containing additional 0.2 phr DSP were reduced in the range from 5 to 40 min. of the test. The YI reduction ranged from about 3 YI units at 5 min. to about 35 YI units at 30 min. It is also remarkable to note that the presence of 0.2 phr DSP enabled to actually reduce the amount of the octyltin stabilizer from 1.2 to 1.0 phr (by about 17% and by doing so reduce tin content in the PVC compound proportionately), while not just maintaining heat stability of the compound but also improving it as expressed via reduction in YI from about 3 YI units at 5 min to about 17 YI units at 25 min. This Example clearly demonstrates synergistic heat stabilizing effect between the octyltin stabilizer and DSP.

### Example 4. Comparative Testing in PVC

PVC pipe compounds were prepared according to the formulation in Table 7.

TABLE 7
Tested PVC pipe compounds

| Components | Manufacturer | Loadings, phr |
|---|---|---|
| 5385 PVC Resin | Westlake | 100.00 |
| Interflo 66 | The International | 1.25 |
| | Group | |
| Calcium Stearate COAD L10 | Norac | 0.50 |
| Eploene E-14P | Westlake | 0.20 |
| Kronos 2220 (TiO₂) | Kronos | 1.50 |
| UFT (Calcium Carbonate, a filler) | J.M Huber | 5.00 |
| Stabilizer | Galata | See Table 8 |

TABLE 8
Dynamic Heat Stability of the tested PVC pipe
compounds (expressed in Yellowness Index)

| | |
|---|---|
| Time, | Stabilizers |

| min. | 1.0 phr Mark 1939 | 1.0 phr Mark 1939/0.25 DSP |
|---|---|---|
| 3 | 6.23 | 7.38 |
| 6 | 7.59 | 8.73 |
| 9 | 10.14 | 10.30 |
| 12 | 14.30 | 12.41 |
| 15 | 20.91 | 16.01 |
| 18 | 25.89 | 21.68 |
| 21 | 30.32 | 28.17 |
| 24 | Blackened | 29.82 |

Results of Table 8 above demonstrate that addition of DSP at 0.25 phr to the Control methyltin stabilizer improved heat stability of PVC, since YI values imparted by the stabilizers containing DSP were reduced. YI values imparted by the stabilizer containing additional 0.25 phr DSP were reduced in the range from 12 to 24 min. of the test. The YI reduction ranged from about 2 YI units at 12 and 21 min. to about 5 YI units at 15 min.

### Example 5. Comparative Testing in PVC

PVC profile compounds were prepared according to the formulation in Table 9.

TABLE 9
Tested PVC profile compounds

| | | Loadings, |
|---|---|---|
| Components | Manufacturer | phr |
| 5385 PVC Resin | Westlake | 100.00 |
| Interflo 66 | The International | 0.80 |
| | Group | |
| Calcium Stearate COAD L10 | Norac | 1.20 |
| Eploene E-14P | Westlake | 0.30 |
| Kronos 2220 (TiO₂) | Kronos Inc. | 9.00 |
| UFT (Calcium Carbonate, a filler) | J.M Huber Corp. | 4.00 |
| Blendex SS370 | Galata | 5.00 |
| Blendex SA200 | Galata | 1.00 |
| Stabilizers | Galata | See Table 10 |
| | | and 11 |

TABLE 10
Dynamic Heat Stability of the tested PVC profile
compounds (expressed in Yellowness Index)

| | |
|---|---|
| Time, | Stabilizers |

| min. | 1.5 phr Mark 1900 | 1.5 phr Mark 1900/0.3 phr DSP |
|---|---|---|
| 3 | 4.96 | 5.17 |
| 6 | 6.65 | 6.45 |
| 9 | 8.48 | 7.92 |
| 12 | 10.88 | 10.06 |
| 15 | 14.60 | 12.86 |
| 18 | 20.10 | 16.13 |
| 21 | 30.01 | 21.95 |
| 24 | 37.31 | 33.40 |
| 27 | Blackened | 34.78 |

Results of Table 10 above demonstrate that addition of DSP at 0.3 phr to the Control methyltin stabilizer improved heat stability of PVC, since YI values imparted by the stabilizers containing DSP were reduced. YI values imparted by the stabilizer containing additional 0.3 phr DSP were reduced in the range from 9 to 27 min. of the test. The YI reduction ranged from <1 YI units at 9 min. to about 8 YI units at 21 min.

### Example 6. Comparative Testing in PVC

PVC profile compounds were prepared according to the formulation in Table 9.

TABLE 11
Dynamic Heat Stability of the tested PVC profile
compounds (expressed in Yellowness Index)

| | Stabilizers | | |
|---|---|---|---|
| Time, | 1.5 phr Mark | 1.5 Mark phr | 1.2 phr Mark |
| min. | 1921E | 1921E/0.3 phr DSP | 1921E/0.3 phr DSP |
| 3 | 6.04 | 4.90 | 5.74 |
| 6 | 6.59 | 6.47 | 6.78 |
| 9 | 8.29 | 7.86 | 8.48 |
| 12 | 10.29 | 9.76 | 11.18 |
| 15 | 16.46 | 12.63 | 16.97 |
| 18 | 26.05 | 21.18 | 23.99 |
| 21 | | 25.54 | |

Results of Table 11 above demonstrate that addition of DSP at 0.3 phr to the Control methyltin stabilizer improved heat stability of PVC, since YI values imparted by the stabilizers containing DSP were reduced. YI values imparted by the stabilizer containing additional 0.3 phr DSP were reduced in the range from 3 to 18-21 min. of the test. The YI reduction ranged from <1 YI units to about 5 YI units at 18 min. It is also remarkable to note that the presence of 0.3 phr DSP enabled to actually reduce the amount of the methyltin stabilizer from 1.5 to 1.2 phr (by 20% and by doing so reduce tin content in the PVC compound proportionately), while practically maintaining heat stability of the compound. This Example clearly demonstrates synergistic heat stabilizing effect between the methyltin stabilizer and DSP.

1. A heat stabilizer composition comprising an alkali metal hydrogen phosphite.

2. The heat stabilizer composition of claim 1 wherein the metal in the alkali metal hydrogen phosphite is selected from lithium, sodium, potassium, rubidium, cesium or mixtures thereof.

3. The heat stabilizer composition of claim 1 wherein the alkali metal hydrogen phosphite is disodium hydrogen phosphite

4. The stabilizer composition according to claim 1 further comprising at least one alkyltin compound selected from the group consisting of alkyltin mercaptides, alkyltin carboxylates, alkyltin sulfides and mixtures thereof.

5. The stabilizer composition according to claim 4, further comprising alkyltin mercaptocarboxylic acid esters and alkyltin 2-mercaptoethylcarboxylates.

6. The stabilizer composition according to claim 5, wherein the alkyltin mercaptocarboxylic esters are selected from the group consisting of mono-alkyltin tris(2-ethylhexyl mercaptoacetate), di-alkyltin bis(2-ethylhexyl mercaptoacetate), dialkyltin bis(ethylene glycol di-mercaptoacetate) and mixtures thereof.

7. The stabilizer composition according to claim 4, where the alkyl groups are selected from the group consisting of methyl, n-butyl, n-octyl and mixtures thereof.

8. The stabilizer composition according to claim 1 further comprising at least one multi-metal-containing component selected from the group consisting of mixed metal compounds, hydrotalcites, zeolites and mixtures thereof.

9. The stabilizer composition according to claim 1 further comprising at least one metal-containing component selected from the group consisting of alkali metal salts of perchloric acid, alkali metal salts of dicarboxylic acids and mixtures thereof.

10. The stabilizer composition according to claim 1 further comprising at least one nitrogen-containing compound selected from the group consisting of 6-amino-1,3-dimethyluracil, thiourea, 1,4-dihydropyridine and mixtures thereof.

11. The stabilizer composition according to claim 1 further comprising at least one organic phosphite ester.

12. A composition comprising a chlorine-containing polymer and the heat stabilizer composition of claim 1.

13. The composition according to claim 12, wherein the chlorine-containing polymer is PVC.

14. The composition according to claim 12, wherein the chlorine-containing polymer is CPVC.

15. A method of stabilizing chlorine-containing polymers, comprising incorporating the heat stabilizer composition according to claim 1 into a chlorine-containing polymer.

16. The method of claim 15 wherein the stabilizer compound is incorporated into the chlorine-containing polymer by dry blending followed by compounding steps selected from injection molding, compression molding, blow molding, slush molding, rotational molding, calendaring, extrusion, paste forming or combinations thereof.

17. The method of claim 15 wherein the stabilizer compound is incorporated into the chlorine-containing polymer by compounding steps selected from injection molding, compression molding, blow molding, slush molding, rotational molding, calendaring extrusion, paste forming or combinations thereof.

18. The composition of claim 1 wherein the alkali metal hydrogen phosphite is present at 0.1 to 5.0 phr.
